(19) United States
(12) Patent Application Publication
(10) Pub. No.: US 2011/0217555 A1
(43) Pub. Date: Sep. 8, 2011

(54) GRANULATED POWDER AND METHOD FOR PRODUCING GRANULATED POWDER

(75) Inventor: Takeshi KADOMURA, Iwata (JP)

(73) Assignee: SEIKO EPSON CORPORATION, Tokyo (JP)

(21) Appl. No.: 13/038,511

(22) Filed: Mar. 2, 2011

(30) Foreign Application Priority Data
Mar. 3, 2010 (JP) 2010-047142

(51) Int. Cl. B32B 15/02; B05D 7/14; B05D 1/02; B32B 15/08

(52) U.S. Cl. 428/407; 427/216; 428/403

(57) ABSTRACT

A granulated powder includes secondary particles obtained by granulation such that a plurality of metal particles in a metal powder are bound to one another by an organic binder and an outer coating layer provided so as to cover the surfaces of the secondary particles. The outer coating layer is formed of a low water-soluble material having a lower water solubility than the organic binder. The material having a lower water solubility than the organic binder is preferably any of an organic amine or a derivative thereof, and an acrylic resin. Further, the outer coating layer is preferably at least partly in contact with the surfaces of the metal particles at an interface with the secondary particle.

### BACKGROUND

1. Technical Field

The present invention relates to a granulated powder and a method for producing a granulated powder.

2. Related Art

As a method for molding a metal powder, a compression molding method is known in which a mixture of a metal powder and an organic binder is filled in a given molding die, followed by compression, thereby obtaining a molded body in a given shape. The obtained molded body is subjected to a degreasing treatment which removes the organic binder and a firing treatment which sinters the metal powder, thereby forming a metal sintered body. Such a technique is an exemplary powder metallurgy technique, and a large amount of a metal sintered body in a complicated shape can be produced according to the shape of the molding die. Therefore, such a technique has been widely spread in many industrial fields.

In the compression molding method, first, it is necessary to fill a metal powder in a molding die as tightly as possible. It is because if there is a space in the molding die, this space remains in the resulting molded body as a hole, resulting in deteriorating the denseness of the metal sintered body in the end.

However, as the metal powder, a fine powder having an average particle diameter of 10 μm or less is sometimes used. Such a fine powder has low fluidity, and therefore has a poor filling property in a molding die. Therefore, a mixture of a metal powder and an organic binder is granulated into particles having a larger particle size to improve the fluidity thereof. When the mixture is granulated, a plurality of particles in the metal powder are bound to one another by the organic binder, thereby forming a granulated powder having a larger particle size. The granulated powder has higher fluidity than the metal powder, and therefore has an excellent filling property in a molding die, and thus, a dense molded body and a dense sintered body can be produced.

For example, JP-A-2008-189993 discloses that when a metal sintered body of an iron-based alloy is produced, a metal powder is granulated using a spheronizer, and thereafter the resulting granulated powder is filled in a molding die cavity, followed by compression molding.

Further, JP-A-2008-189993 discloses that by forming the granulated powder into a spherical shape to increase the fluidity of the granulated powder, the amount of the starting material powder to be filled in the die cavity does not vary and the weight of the resulting molded body is stabilized.

However, although the fluidity of the granulated powder can be increased by forming the granulated powder into a spherical shape, in the case where there is a narrow portion in the molding die or the molding die has a deep portion, a problem arises in the filling property of the granulated powder and there is a possibility that a product having a desired shape may not be obtained.

### SUMMARY

An advantage of some aspects of the invention is to provide a granulated powder which has high fluidity and also has a high filling property at the time of molding, and also to provide a method for producing a granulated powder capable of efficiently producing such a granulated powder.

In accordance with an aspect of the invention, there is provided a granulated powder comprising secondary particles including a plurality of metal particles bound to one another by an organic binder, and an outer coating layer provided covering the surfaces of the secondary particles, wherein the outer coating layer is formed of a low water-soluble material having a lower water solubility than the organic binder.

According to this configuration, a granulated powder which has high fluidity and also has a high filling property at the time of molding can be obtained. By using such a granulated powder, a sintered body having a high density and high dimensional accuracy can be obtained.

In accordance with the aspect of the invention, an amount of the outer coating layer is preferably from 0.02 to 0.8 parts by weight based on 100 parts by weight of the metal particles.

According to this configuration, an outer coating layer having the right thickness is formed, and the fluidity of the granulated powder can be sufficiently increased.

In accordance with the aspect of the invention, the low water-soluble material preferably any of an organic amine or a derivative thereof, and an acrylic resin.

According to this configuration, an outer coating layer having low hygroscopicity is formed, and therefore, the fluidity of the granulated powder can be particularly increased. Further, the chance of contact between the secondary particles and the outside air can be reduced, and therefore, the metal particles can be protected from oxygen, moisture, and the like, and a sintered body having a high density, a low oxygen content, and excellent weather resistance can be obtained in the end.

In accordance with the aspect of the invention, the low water-soluble material is preferably an organic amine or a derivative thereof, and the outer coating layer is at least partly in contact with the surfaces of the metal particles.

According to this configuration, an amino group in the organic amine is spontaneously and strongly adsorbed onto the surfaces of the metal particles. As a result, the probability of detachment of the outer coating layer can be decreased, and the fluidity and weather resistance of the granulated powder can be stably increased.

In accordance with the aspect of the invention, the organic amine or a derivative thereof is preferably at least one of an alkylamine, a cycloalkylamine, an alkanolamine, and a derivative thereof.

These organic amines have a low interaction potential, and therefore contribute to further improvement of the fluidity of the granulated powder.

In accordance with the aspect of the invention, the organic amine derivative is preferably any of a nitrite of an organic amine, a carboxylate of an organic amine, a chromate of an organic amine, and an acetate of an organic amine.

These organic amine derivatives have a low interaction potential, and therefore contribute to further improvement of the fluidity of the granulated powder.

In accordance with the aspect of the invention, the organic binder preferably contains polyvinyl alcohol or polyvinylpyrrolidone.

These binder components have a high binding property, and therefore, even if the addition amount thereof is a relatively small amount, a granulated powder can be efficiently formed. Further, these binder components have high thermal decomposability, and therefore can be decomposed and removed reliably in a short time during degreasing and firing.

In accordance with the aspect of the invention, each of the metal particles is preferably covered with an inner coating layer formed of the same material as the outer coating layer.

According to this configuration, two coating layers are formed, and the chance of contact between the metal material which constitutes the metal particles and the outside air can be further reduced. Further, when the granulated powder is filled in a molding die and is molded, a compression force is applied to each of the particles of the granulated powder, thereby disintegrating the particles, and the lubricating property of the metal particles at this time can be increased. As a result, the shape retaining property of a molded body is increased, and a sintered body having high dimensional accuracy can be obtained in the end.

In accordance with the aspect of the invention, the metal particles preferably comprise an Fe-based alloy powder and the granulated powder preferably has a fluidity of 33 (sec/50 g) or less, as measured in accordance with Test Method for Fluidity of Metal Powders specified in JIS Z 2502.

According to this configuration, a granulated powder which can flow into a narrow portion or a deep portion of a molding die without forming any space even if the molding die has a narrow portion or a deep portion in part, and therefore can be reliably filled in the molding die can be obtained. As a result, a sintered body which is homogeneous and has a high density can be obtained.

In accordance with another aspect of the invention, there is provided a method for producing a granulated powder comprising: providing a plurality of metal particles; while tumbling or flowing the plurality of metal particles, simultaneously supplying a solution of an organic binder to the plurality of metal particles, thereby obtaining a secondary particles; and supplying a solution of a low water-soluble material having a lower water solubility than the organic binder to the secondary particles, thereby forming an outer coating layer.

According to this configuration, a granulated powder having high fluidity and also having a high filling property at the time of molding can be efficiently produced.

In accordance with the aspect of the invention, the solution of the low water-soluble material is preferably supplied by spraying.

According to this configuration, this solution is gradually supplied to the secondary particles, and therefore, disintegration of the secondary particles can be prevented as compared with the case where this solution is supplied in a large amount at once. In addition, the solution of the material having a low water solubility can be supplied without any waste, and thus, the supply amount thereof can be easily controlled.

### BRIEF DESCRIPTION OF THE DRAWINGS

The invention will be described with reference to the accompanying drawings, wherein like numbers reference like elements.

FIG. 1 is a cross-sectional view showing an embodiment of one particle in a granulated powder according to the invention.

FIG. 2 is a cross-sectional view showing another exemplary structure of a granulated powder according to the invention.

FIGS. 3A and 3B are schematic views showing a structure of a tumbling granulator to be used in a method for producing a granulated powder according to the invention.

FIG. 4 is a graph showing the distribution of granulated powders obtained in the respective Examples 1B to 8B and Comparative Example 1B with the horizontal axis representing the addition amount of a material having a low water solubility, and the vertical axis representing the fluidity of a granulated powder in a case where polyvinyl alcohol was used as organic binder.

FIG. 5 is a graph showing the distribution of granulated powders obtained in the respective Examples 9B to 16B and Comparative Example 2B with the horizontal axis representing the addition amount of a material having a low water solubility, and the vertical axis representing the fluidity of a granulated powder in a case where polyvinylpyrrolidone was used as organic binder.

### DESCRIPTION OF EXEMPLARY EMBODIMENTS

Hereinafter, the granulated powder and the method for producing a granulated powder according to the invention will be described in detail by way of preferred embodiments with reference to the accompanying drawings.

The granulated powder according to the invention contains a metal powder and an organic binder, and includes secondary particles obtained by granulation such that a plurality of metal particles in the metal powder are bound to one another by the organic binder.

Further, the granulated powder according to the invention includes an outer coating layer covering the surfaces of the secondary particles. The outer coating layer is formed of a low water-soluble material having a lower water solubility than the organic binder.

Such a granulated powder has high fluidity and also has a high filling property at the time of molding because it is provided with the outer coating layer. Accordingly, by using such a granulated powder, a sintered body having excellent moldability (mold transferring property) and a high density can be obtained.

Hereinafter, the granulated powder according to the invention will be described in detail.

### Metal Powder

The metal powder to be contained in the granulated powder according to the invention is not particularly limited, and examples thereof include Mg, Al, Ti, V, Cr, Mn, Fe, Co, Ni, Cu, Zn, Y, Zr, Nb, Mo, Pd, Ag, In, Sn, Ta, W, and alloys thereof.

Among these, as the metal powder, a powder of any of a variety of Fe-based alloys such as stainless steel, dies steel, high-speed tool steel, low-carbon steel, Fe—Ni alloy, and Fe—Ni—Co alloy is preferably used. Since such an Fe-based alloy has an excellent mechanical property, a sintered body obtained using this Fe-based alloy powder has an excellent mechanical property and can be used in a wide range of applications.

Examples of the stainless steel include SUS 304, SUS 316, SUS 317, SUS 329, SUS 410, SUS 430, SUS 440, and SUS 630.

Further, the average particle diameter of the metal powder is preferably from 1 to 30 μm, more preferably from 3 to 20 μm, further more preferably from 3 to 10 μm. The metal powder having such a particle diameter is capable of producing a sufficiently dense sintered body in the end while avoiding a decrease in the compressibility at the time of molding.

If the average particle diameter is less than the lower limit defined above, the metal powder may aggregate before granulation, and a variation in the content of the metal powder may occur among the particles of the granulated powder or the compressibility at the time of molding may be significantly decreased. On the other hand, if the average particle diameter exceeds the upper limit defined above, the space between the particles of the granulated powder at the time of molding may be too large, and the densification of the finally obtained sintered body may be insufficient.

The tap density of the metal powder to be used in the invention is, e.g. in the case of an Fe-based alloy powder, preferably 3.5 g/cm³ or more, more preferably 3.8 g/cm³ or more. When the metal powder has a high tap density as described above, at the time of obtaining the granulated powder, interparticle filling is particularly increased. Therefore, a particularly dense sintered body can be obtained.

The specific surface area of the metal powder to be used in the invention is not particularly limited, however, it is preferably 0.15 m²/g or more, more preferably 0.2 m²/g or more, further more preferably 0.3 m²/g or more. When the metal powder has a large specific surface area as described above, the surface activity (surface energy) is increased, and therefore, sintering can be easily performed even if lower energy is applied. Accordingly, sintering can be achieved in a shorter time when the molded body is sintered. As a result, the sintered body can be densified even if the molded body is fired at a low temperature.

Such a metal powder may be, for example, produced by any method, however, a metal powder produced by, for example, an atomization method (a water atomization method, a gas atomization method, a high-speed spinning water atomization method, etc.), a reduction method, a carbonyl method, a pulverization method, or the like can be used.

In particular, a metal powder produced by an atomization method is preferably used as the metal powder. By the atomization method, it is possible to efficiently produce a metal powder having an extremely small average particle diameter as described above. Further, it is possible to obtain a metal powder having a uniform particle diameter and a small variation in particle diameter. Accordingly, by using such a metal powder, air holes can be reliably prevented from being generated in the sintered body, and the density can be improved.

The metal powder produced by an atomization method has a spherical shape relatively close to a true sphere, and therefore has excellent dispersibility and fluidity in the binder. Therefore, when the granulated powder is filled in a molding die to effect molding, the filling property and uniformity can be increased, and a dense sintered body can be obtained in the end.

### Organic Binder

Examples of the organic binder to be contained in the granulated powder according to the invention include various resins such as polyolefins including polyethylene, polypropylene, ethylene-vinyl acetate copolymers, and the like; acrylic resins including polymethyl methacrylate, polybutyl methacrylate, and the like; styrene resins including polystyrene and the like; polyesters including polyvinyl chloride, polyvinylidene chloride, polyamide, polyethylene terephthalate, polybutylene terephthalate, and the like; polyether, polyvinyl alcohol, polyvinylpyrrolidone, and copolymers thereof; various waxes, paraffin, higher fatty acids (for example, stearic acid), higher alcohols, higher fatty acid esters, and higher fatty acid amides, and these can be used alone or in admixture of two or more.

Among these, as the organic binder, one containing polyvinyl alcohol or polyvinylpyrrolidone is preferred. These binder components have a high binding property, and therefore, even if the addition amount thereof is a relatively small amount, a granulated powder can be efficiently formed. Further, these binder components have high thermal decomposability, and therefore can be decomposed and removed reliably in a short time during degreasing and firing.

From the viewpoint that an outer coating layer 6 has hydrophobicity (oil solubility), by using polyvinyl alcohol or polyvinylpyrrolidone having high hydrophilicity (water solubility) as the organic binder, an oil-soluble solvent can be used as a solvent to be used when the outer coating layer 6 is formed. That is, by using an oil-soluble solvent when the outer coating layer 6 is formed, the organic binder can be prevented from dissolving, and the secondary particles can be effectively prevented from disintegrating.

The content of the organic binder is preferably from about 0.2 to 10% by mass, more preferably from about 0.3 to 5% by mass, further more preferably from 0.3 to 2% by mass of the total mass of the granulated powder. By allowing the content of the organic binder to fall within the above range, the granulated powder can be efficiently formed while reliably preventing the particles having a significantly large size from being formed or ungranulated metal particles from remaining. Further, since the molding property is increased, the stability of the shape of the molded body and the like can be made particularly excellent. Further, by allowing the content of the organic binder to fall within the above range, a difference in size between the molded body and the degreased body, in other words, a shrinkage ratio is optimized, and the dimensional accuracy of the finally obtained sintered body can be prevented from decreasing.

### Granulated Powder

The granulated powder according to the invention includes secondary particles in which a plurality of metal particles in the metal powder as described above are bound to one another by the organic binder as described above, and an outer coating layer that covers the surfaces of the secondary particles.

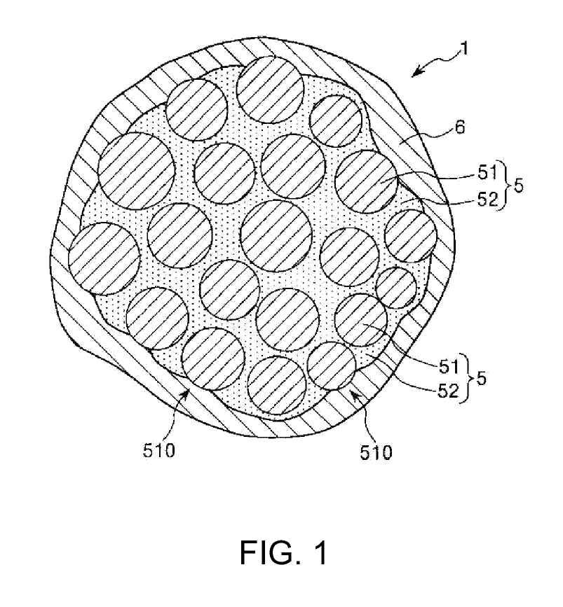

FIG. 1 is a cross-sectional view showing an embodiment of one particle in the granulated powder according to the invention.

A granulated particle 1 in the granulated powder according to the invention has a secondary particle 5 and an outer coating layer 6.

The secondary particle 5 contains a plurality of metal particles 51 and also an organic binder 52 intervening between the respective particles, and therefore has a spherical shape as a whole.

In the secondary particle 5 shown in FIG. 1, the organic binder 52 intervenes between the metal particles 51 and is present so as to cover the respective metal particles 51. According to this configuration, the respective metal particles 51 are in a dispersed state in a matrix of the organic binder 52.

On the other hand, the outer coating layer 6 is provided so as to cover the surface of the secondary particle 5. This outer coating layer 6 is formed of a low water-soluble material having a lower water solubility than the organic binder.

Because of having this outer coating layer 6, the granulated particle 1 has high fluidity and high weather resistance. This is because the low water-soluble material having a lower water solubility than the organic binder also has low hygroscopicity. That is, an increase in the frictional coefficient of the surface of the granulated particle 1 due to moisture absorption can be prevented, and therefore, the fluidity and weather resistance of the granulated particle 1 can be increased.

In the case where the granulated particle 1 is filled in a molding die and is molded, the outer coating layer 6 can prevent the granulated particle 1 from adhering to the molding die, and therefore, can increase the releasing property of the resulting molded body.

Moisture absorption of the granulated particle 1 can occur in a normal atmosphere even if it is not in a high-humidity environment. In particular, during summer when the humidity increases, a problem that a decrease in fluidity and weather resistance of the granulated particle 1 due to moisture absorption was significant. Therefore, a seasonal variation in property of the granulated particle 1 occurred and the property of the finally obtained sintered body was also not uniform in the related art.

On the other hand, according to the invention, there is less seasonal variation in property of the granulated particle 1 as described above, and a sintered body having a uniform property can be produced.

Examples of the low water-soluble material as described above include an organic amine or a derivative thereof, an acrylic resin, a surfactant, and polyvinyl butyral.

Among these, any of an organic amine or a derivative thereof, and an acrylic resin is preferably used.

The organic amine contains an amino group having a relatively high activity in each molecule, and this amino group is adsorbed onto the surface of the secondary particle 5, whereby the friction between the secondary particles 5 can be reduced. Further, when the amino group is adsorbed onto the surface of the secondary particle 5, the probability that a functional group having a relatively low activity is oriented to the side (outside) opposite to the side of the secondary particle 5 is increased. This functional group has a low interaction potential with the same functional group and also has hydrophobicity, and therefore, even if the secondary particles 5 come close to each other, the probability of occurrence of interaction between the particles is decreased. In addition, the hygroscopicity of the outer coating layer 6 is also decreased. As a result, the fluidity of the granulated powder is increased, and also the distance between the secondary particles 5 is easily decreased, and therefore, the organic amine contributes to the densification of a molded body and a sintered body.

On the other hand, the acrylic resin has a high adsorbing property to various organic binder components and is hydrophobic. Therefore, the outer coating layer 6 formed of the acrylic resin has low hygroscopicity and contributes to the improvement of the fluidity of the granulated powder.

In addition, the organic amine or a derivative thereof or the acrylic resin adsorbed onto the surface of the secondary particle 5 reduces the chance of contact between the secondary particle 5 and the outside air, and therefore protects the metal particles 51 from oxygen, moisture, and the like, and increases the weather resistance of the metal particles 51. As a result, a sintered body having a high density, a low oxygen content, and excellent weather resistance can be obtained in the end.

The amount of the outer coating layer 6 is not particularly limited, however, it is preferably from 0.02 to 0.8 parts by weight, more preferably from 0.05 to 0.6 parts by weight, further more preferably from 0.07 to 0.5 parts by weight based on 100 parts by weight of the metal particles 51. By allowing the amount of the outer coating layer 6 to fall within the above range, an outer coating layer 6 having the right thickness is formed, and the fluidity of the granulated powder can be sufficiently increased. To be more specific, as compared with the case where the outer coating layer 6 is not formed, the fluidity of the granulated powder can be increased by 1.5% or more. By improving the fluidity in this manner, it is possible to increase the relative density of the finally obtained sintered body by 2% or more.

If the amount of the outer coating layer 6 is lower than the lower limit defined above, the probability that the outer coating layer 6 becomes discontinuous may be increased. On the other hand, if the amount of the outer coating layer 6 exceeds the upper limit defined above, the amount of the outer coating layer 6 in the entire granulated powder becomes too high, and the outer coating layer 6 may remain in the sintered body or the density of the sintered body may be decreased.

Examples of the organic amine or a derivative thereof include alkylamines, cycloalkylamines, alkanolamines, allylamines, arylamines, alkoxyamines, and derivatives thereof. Among these, particularly, at least one of alkylamines, cycloalkylamines, alkanolamines, and derivatives thereof is preferably used. The outer coating layer 6 formed of one or more of these amines has a low interaction potential and contributes to further improvement of the fluidity of the granulated powder.

Examples of the alkylamine include monoalkylamines such as n-hexylamine, n-heptylamine, n-octylamine (normal-octylamine), and 2-ethylhexylamine; dialkylamines such as diisobutylamine; and trialkylamines such as diisopropylethylamine.

Examples of the cycloalkylamine include cyclohexylamine and dicyclohexylamine.

Examples of the alkanolamine include monoethanolamine, diethanolamine, triethanolamine, monopropanolamine, dipropanolamine, tripropanolamine, N,N-dimethylethanolamine, N,N-diethylethanolamine, N-aminoethylethanolamine, N-methylethanolamine, and N-methyldiethanolamine.

As the derivative of such an organic amine, although it is not particularly limited, preferably, a nitrite of an organic amine, a carboxylate of an organic amine, a chromate of an organic amine, an acetate of an organic amine, or the like can be used. The outer coating layer 6 formed of such an amine has a low interaction potential and contributes to further improvement of the fluidity of the granulated powder.

Examples of the acrylic resin include poly(alkyl (meth)acrylates) such as poly(methyl (meth)acrylate), poly(butyl (meth)acrylate), poly(isobutyl (meth)acrylate), poly(2-ethylhexyl (meth)acrylate), and poly(lauryl (meth)acrylate); and copolymers obtained by copolymerization of two or more monomers of the above poly(alkyl (meth)acrylates).

A copolymer resin derived from a monomer of any of the above poly(alkyl (meth)acrylates) and another monomer copolymerizable therewith (for example, glycidyl methacrylate, hydroxy methacrylate, styrene, or the like) may be used within a range that does not impair the decomposability of the acrylic resin.

These resins may be used alone or in combination of two or more. The term “(meth)acrylate” as used herein refers to methacrylate or acrylate.

Among the above-mentioned (meth)acrylic resins, from the viewpoint of thermal decomposability, polybutyl methacrylate, polyisobutyl methacrylate, polylauryl methacrylate, or a resin composed mainly of any of these is preferably used.

The average thickness of the outer coating layer 6 is preferably from about 1 to 1000 nm, more preferably from about 5 to 500 nm. By allowing the average thickness thereof to fall within the above range, the improvement of the fluidity and weather resistance of the granulated powder by the outer coating layer 6 is sufficiently achieved.

If the average thickness of the outer coating layer 6 is lower than the lower limit defined above, the probability that the outer coating layer 6 becomes discontinuous is increased. On the other hand, if the average thickness of the outer coating layer 6 exceeds the upper limit defined above, the abundance ratio of the outer coating layer 6 in the entire granulated powder may become too high.

As described above, in the secondary particle 5 shown in FIG. 1, the organic binder 52 intervenes between the metal particles 51 and is present so as to cover the respective metal particles 51. Therefore, at the interface between the outer coating layer 6 and the secondary particle 5, the outer coating layer 6 and the organic binder 52 are mainly in contact with each other.

Here, the surface of the secondary particle 5 preferably has a portion where the metal particle 51 is exposed on a part thereof (an exposed portion 510 shown in FIG. 1). At such an exposed portion 510 of the metal particle 51, the outer coating layer 6 more strongly adheres and also the density of the outer coating layer 6 is increased. It is considered that this is because an amino group in the outer coating layer 6 is spontaneously adsorbed onto the exposed portion 510. Incidentally, this adsorption is considered to be due to an interaction between the lone pair of electrons of the amino group which is a polar group and an adsorption site of the exposed portion 510. Due to such an interaction, the probability of detachment of the outer coating layer 6 can be decreased, and the granulated particle 1 which can stably increase the fluidity and weather resistance can be obtained.

The granulated powder as described above has high fluidity. To be more specific, in the case where an Fe-based alloy powder is used as the metal powder, the fluidity of the granulated powder according to the invention is preferably 33 (sec/50 g) or less, as measured in accordance with Test Method for Fluidity of Metal Powders specified in JIS Z 2502. More preferably, the fluidity is 32 (sec/50 g) or less, furthermore preferably 31 (sec/50 g) or less. A granulated powder having such fluidity can flow into a narrow portion or a deep portion of a molding die without forming any space even if the molding die has a narrow portion or a deep portion in part, and therefore can be reliably filled in the molding die. As a result, a sintered body which has a desired dimension, is homogeneous, and has a high density can be obtained.

The fluidity of the granulated powder is measured as follows.

First, a funnel which has been calibrated for measurement is prepared, and 50 g of the granulated powder to be measured is put in the funnel with the orifice thereof closed.

Subsequently, the orifice is opened and at the same time, the time keeping is started. Then, the time keeping is finished immediately after the last granulated powder comes out from the orifice.

Subsequently, the average time required for dropping of the granulated powder is multiplied by a correction coefficient set for the funnel, and the resulting value is defined as a measurement of the fluidity.

As described above, the fluidity is measured.

Further, the shape of each particle of the granulated powder according to the invention greatly affects the fluidity and the filling property. From this viewpoint, the shape of each particle of the granulated powder is preferably a shape close to a true sphere.

### Another Exemplary Structure

Here, another exemplary structure of the granulated powder according to the invention will be described.

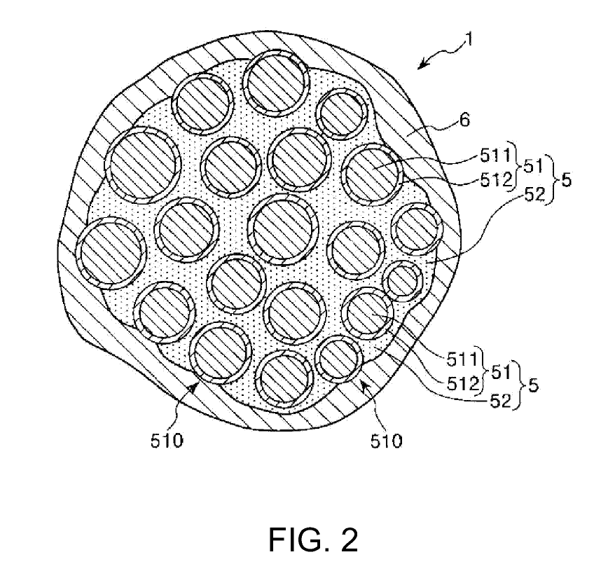

FIG. 2 is a cross-sectional view showing another exemplary structure of the granulated powder according to the invention.

The granulated particle 1 shown in FIG. 2 has the same structure as the granulated particle 1 shown in FIG. 1 except that the metal particle 51 comprises a core portion 511 and an inner coating layer 512 which covers the core portion 511.

The core portion 511 is formed of any of various metal materials in the same manner as the metal particle 51 in FIG. 1.

Meanwhile, the inner coating layer 512 is formed of an organic amine in the same manner as the outer coating layer 6 in FIG. 1 and has the same configuration as the outer coating layer 6.

That is, the granulated particle 1 shown in FIG. 2 has two coating layers such that the inner coating layer 512 which directly covers the core portion 511 formed of a metal material and the outer coating layer 6 which covers the secondary particle 5 including the core portion 511 and the inner coating layer 512. Accordingly, the granulated particle 1 shown in FIG. 2 has the same fluidity as the granulated particle 1 shown in FIG. 1 and also has superior weather resistance to the granulated particle 1 shown in FIG. 1. This is because the chance of contact between the core portion 511 and the outside air can be further reduced by the two coating layers. By using such a granulated powder, a sintered body having a particularly high density can be obtained.

In the case where the granulated particles 1 are filled in a molding die and are molded, a compression force is applied to the granulated particles 1, whereby the particles are molded into a given shape. At this time, the granulated particle 1 is disintegrated, whereby the shape retaining property of the molded body is exhibited. Since the inner coating layer 512 which covers the core portion 511 is provided, the lubricating property of the metal particles 51 is increased, and smooth disintegration is achieved. As a result, the shape retaining property of the molded body is increased, and a sintered body having a high dimensional accuracy can be obtained.

### Method for Producing Granulated Particle

Subsequently, an embodiment of the method for producing a granulated powder according to the invention will be described.

Hereinafter, prior to the description of the method for producing a granulated powder, a granulator to be used in this production method will be described.

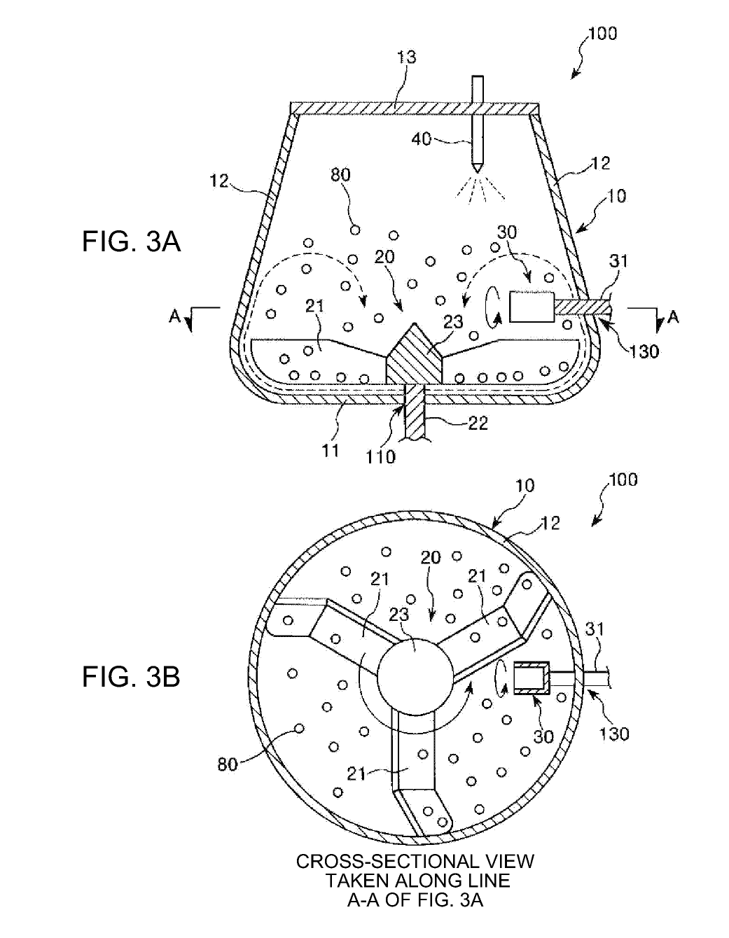

FIGS. 3A and 3B are schematic views showing a structure of a tumbling granulator to be used in the method for producing a granulated powder according to the invention: FIG. 3A is a vertical cross-sectional view of the tumbling granulator; and FIG. 3B is a cross-sectional view taken along the line A-A of FIG. 3A.

A tumbling granulator 100 is provided with a treatment vessel 10 for performing granulation, a blade 20 and a cross screw 30 installed in the treatment vessel 10, and a spray nozzle 40.

As shown in FIG. 3A, the treatment vessel 10 has a bottom portion 11 and a side wall portion 12 vertically provided from the bottom portion 11. The side wall portion 12 has a conical shape (for example, a circular truncated cone tube shape) in which the inner and outer diameters gradually increase from the top to the bottom. Since the treatment vessel 10 (side wall portion 12) has such a shape, an air current can be formed in the treatment vessel 10 such that a powder blown up by the blade 20 at the outer periphery of the treatment vessel 10 falls at the center of the treatment vessel 10. As a result, the powder can be uniformly treated, and therefore, a granulated powder having a sharp particle size distribution can be efficiently produced.

The treatment vessel 10 has an opening on the top, and a lid 13 is attached thereto so as to close the opening.

The blade 20 has a base portion 23, and three rotary vanes 21, which are fixed to the base portion 23 at one end thereof and are arranged radially at approximately equal intervals.

In the center of the bottom portion 11 of the treatment vessel 10, a through-hole 110 is provided, and a rotary drive shaft 22 is inserted into this through-hole 110.

The upper end of the rotary drive shaft 22 is fixed to the base portion 23 and the lower end thereof is connected to a rotary driving source (not shown). Then, the rotary drive shaft 22 is rotationally driven in the forward reverse directions by this rotary driving source, thereby rotating the blade 20.

Each of the rotary vanes 21 is fixed inclined with respect to the rotary drive shaft 22 such that it is inclined downwardly toward the front side in the rotating direction of the blade 20. According to this configuration, as the blade 20 rotates, the powder can be effectively thrown up and an air current as described above can be formed.

In the side wall portion 12 of the treatment vessel 10, a through-hole 130 is provided, and a rotary drive shaft 31 is inserted into this through-hole 130.

One end of the rotary drive shaft 31 is fixed to the cross screw 30, and the other end thereof is connected to a rotary driving source (not shown). Then, the rotary drive shaft 31 is rotationally driven in the forward reverse directions by this rotary driving source, thereby rotating the cross screw 30.

The spray nozzle 40 is provided such that it pierces the lid 13 attached to the treatment vessel 10, and a supply port is located in the treatment vessel 10. According to this configuration, a solvent can be sprayed in the treatment vessel 10. By spraying a solvent from the spray nozzle 40, a descending air current is formed in the vicinity of the spray nozzle 40.

Here, the operation of the tumbling granulator 100 as described above, that is, the method for producing a granulated powder using the tumbling granulator 100 will be described. The method for producing a granulated powder using the tumbling granulator 100 is one example of the method for producing a granulated powder according to the invention, and it is a matter of course that the method for producing a granulated powder according to the invention is not limited thereto.

Subsequently, the method for producing a granulated powder using the above tumbling granulator 100 will be described.

The method for producing a granulated powder includes: a first step of allowing a metal powder to tumble and/or flow while supplying a solution of an organic binder (a binder solution), thereby granulating the metal powder to obtain secondary particles; and a second step of supplying a solution of a low water-soluble material, thereby forming a coating layer.

(1) First, a metal powder is fed to the treatment vessel 10 of the tumbling granulator 100 as described above. Then, by stirring the metal powder with the blade 20, the metal powder is allowed to tumble and/or flow.

Concurrently with this, the binder solution is sprayed from the spray nozzle 40. The binder solution in the mist form wets the metal powder and also binds the particles of the metal powder. As a result, the metal powder is granulated, whereby a granulated powder 80 is obtained. This granulated powder 80 gradually moves (tumbles) toward the outer periphery (toward the side wall portion 12) of the treatment vessel 10 as the blade 20 rotates and also is thrown up above by the rotary vanes 21. The thrown-up granulated powder 80 falls at the center of the treatment vessel 10 and is allowed to tumble again by the blade 20. When a series of processes as described above is repeated, the granulated powder is properly shaped, whereby the granulated power 80 having a shape close to a true sphere is formed.

In such a granulation process, when the particles during granulation come in contact with the rotating cross screw 30, particles having a large particle diameter (particles in which the degree of granulation progress is high) are crushed. By doing this, excessive granulation is prevented, and the particle size distribution of the granulated powder is controlled to be narrow.

The binder solution may be supplied by any method, for example, by placing the binder solution in the treatment vessel 10 in advance, etc., however, it is preferred that the binder solution is sprayed from the top as shown in FIG. 3A. By doing this, the right amount of the binder solution is supplied uniformly to the granulated powder 80 thrown-up by the blade 20, and therefore, the shape and size of the granulated powder 80 can be made uniform. In particular, by allowing the granulated powder 80 to come in contact with the binder solution while floating in the air, the entire surface of the particles of the granulated powder 80 is wetted uniformly, and therefore, the uniformity becomes more prominent. As a result, the granulated powder 80 having a uniform particle size distribution can be obtained.

Examples of the solvent to be used in the binder solution include inorganic solvents such as water, carbon disulfide, and carbon tetrachloride; and organic solvents including ketone-based solvents such as methyl ethyl ketone (MEK), acetone, diethyl ketone, methyl isobutyl ketone (MIBK), methyl isopropyl ketone (MIPK), cyclohexanone, 3-heptanone, and 4-heptanone; alcohol-based solvents such as methanol, ethanol, n-propanol, isopropanol, n-butanol, i-butanol, t-butanol, 3-methyl-1-butanol, 1-pentanol, 2-pentanol, n-hexanol, cyclohexanol, 1-heptanol, 1-octanol, 2-octanol, 2-methoxyethanol, allyl alcohol, furfuryl alcohol, and phenol; ether-based solvents such as diethyl ether, dipropyl ether, diisopropyl ether, dibutyl ether, 1,2-dimethoxyethane (DME), 1,4-dioxane, tetrahydrofuran (THF), tetrahydropyran (THP), anisole, diethylene glycol dimethyl ether (diglyme), and 2-methoxyethanol; cellosolve-based solvents such as methyl cellosolve, ethyl cellosolve, and phenyl cellosolve; aliphatic hydrocarbon-based solvents such as hexane, pentane, heptane, cyclohexane, methyl cyclohexane, octane, didecane, methylcyclohexene, and isoprene; aromatic hydrocarbon-based solvents such as toluene, xylene, benzene, ethylbenzene, and naphthalene; aromatic heterocyclic compound-based solvents such as pyridine, pyrazine, furan, pyrrole, thiophene, 2-methylpyridine, 3-methylpyridine, 4-methylpyridine, and furfuryl alcohol; amide-based solvents such as N,N-dimethylformamide (DMF) and N,N-dimethylacetoamide (DMA); halogen compound-based solvents such as dichloromethane, chloroform, 1,2-dichloroethane, trichloroethylene, and chlorobenzene; ester-based solvents such as acetylacetone, ethyl acetate, methyl acetate, isopropyl acetate, isobutyl acetate, isopentyl acetate, ethyl chloroaceate, butyl chloroacetate, isobutyl chloroacetate, ethyl formate, isobutyl formate, ethyl acrylate, methyl methacrylate, and ethyl benzoate; amine-based solvents such as trimethylamine, hexylamine, triethylamine, and aniline; nitrile-based solvents such as acrylonitrile and acetonitrile; nitro-based solvents such as nitromethane and nitroethane; and aldehyde-based solvents such as acetoaldehyde, propione aldehyde, butyl aldehyde, pentanal, and acrylaldehyde. These can be used alone or in admixture of two or more.

The number of rotations per unit time (hereinafter simply referred to as “rotation speed”) of the blade 20 is not particularly limited as long as it can ensure at least tumbling of the granulated powder 80, however, for example, it is preferably from about 50 to 500 rpm, more preferably from about 100 to 300 rpm. When the rotation speed of the blade 20 falls within the above range, the granulated powder 80 can be allowed to efficiently tumble and granulation can be efficiently performed.

If the rotation speed of the blade 20 is less than the lower limit defined above, tumbling or throwing-up of the granulated powder 80 is insufficient, which may cause uneven granulation. Further, the granulated powder 80 which has not a spherical shape but an irregular shape with low fluidity may be formed. On the other hand, if the rotation speed of the blade 20 exceeds the upper limit defined above, the granulated particles are crushed more than necessary by the blade 20.

The number of rotations per unit time of the cross screw 30 at the time of granulation is not particularly limited, however, it is preferably from about 50 to 3500 rpm, more preferably from about 100 to 3000 rpm. According to this configuration, particles having a large particle diameter can be crushed while preventing excessive crushing of the particles so that the particle diameter can be made uniform.

The supply rate of the binder solution is not particularly limited. It is preferably from 20 to 1000 g/min, more preferably from 30 to 800 g/min, further more preferably from 50 to 600 g/min. When the supply rate of the binder solution falls within the above range, binding (granulation) of the metal powder by the binder solution is uniformly performed and the particle size distribution of the resulting granulated powder can be made sharper.

However, if the supply rate of the binder solution is less than the lower limit defined above, uneven granulation may result. On the other hand, if the supply rate of the binder solution exceeds the upper limit defined above, the granulation may proceed excessively. As a result, the resulting granulated powder may have a wide particle size distribution.

The concentration of the organic binder in the binder solution is preferably from 0.5 to 20% by weight, more preferably from 1 to 15% by weight, further more preferably from 2 to 13% by weight.

The treatment time (stirring time) for granulation is not particularly limited. It is preferably from 1 to 90 minutes, more preferably from 2 to 85 minutes, further more preferably from 3 to 80 minutes. According to this configuration, ungranulated metal powder can be prevented from remaining, and the particle size distribution of the resulting granulated powder can be made sharp. If the treatment time for granulation is less than the lower limit defined above, a relatively large amount of a powder having a small particle diameter (ungranulated metal powder, etc.) may remain. On the other hand, if the treatment time for granulation exceeds the upper limit defined above, a solvent may be directly applied to a powder having a relatively large particle diameter (a lump of a powder which does not tumble or flow) to cause uneven granulation.

A solvent which can dissolve the organic binder may be sprayed (supplied) to the granulated powder as needed. According to this configuration, the granulated powder having a more uniform shape and size can be formed.

The granulated powder 80 is obtained in a sufficiently dried state in the end.

As described above, the secondary particles in which a plurality of the metal particles are bound to one another by the organic binder are obtained.

### First Step

Although the method for producing the secondary particles using the tumbling granulator 100 (a tumbling granulation method) is described in the above, the method for producing the secondary particles is not limited to the above-mentioned method. For example, a fluidized bed granulation method, a tumbling fluidized bed granulation method, a spray drying method, or the like can also be used.

The obtained secondary particles are subjected to a vibration treatment, a crushing treatment, or the like as needed to remove a part of the organic binder on the surfaces of the secondary particles, whereby the metal particles can also be exposed on the surfaces. By doing this, as described above, adhesion between the secondary particles and the outer coating layer 6 can be increased.

Without performing the above treatment, by reducing the addition amount of the organic binder, the metal particles can also be exposed on the surfaces.

(2) Subsequently, the obtained secondary particles are placed in a vessel, and a solution of a low water-soluble material is supplied from the top (second step). By doing this, a liquid coating film of the low water-soluble material is formed on the surfaces of the secondary particles, and the coating film is dried, whereby the outer coating layer 6 is formed.

The supply method is not particularly limited. Examples thereof include a method of spraying the solution and a method of immersing the secondary particles in the solution. Among these, a method of spraying the solution is preferably used. According to this method, the solution of the low water-soluble material can be efficiently supplied so as to cover the surfaces of the respective secondary particles while controlling the amount of the solution used.

When the solution of the low water-soluble material is sprayed, the above-mentioned tumbling granulator 100 may be used.

That is, after producing the secondary particles using the tumbling granulator 100, the solution to be sprayed is changed from the organic binder solution to the solution of the low water-soluble material, and the tumbling granulator 100 is operated. As a result, there is no need to prepare an additional vessel and the like, and this step can be efficiently performed.

By spraying the solution of the low water-soluble material, this solution is gradually supplied to the secondary particles, and therefore, disintegration of the secondary particles can be prevented as compared with the case where this solution is supplied in a large amount at once. In addition, the solution of the low water-soluble material can be supplied without any waste, and thus, the supply amount thereof can be easily controlled.

Due to the action of tumbling and/or flowing, the secondary particles rotate, and therefore, the chance of contact between the surfaces of the secondary particles and the solution of the low water-soluble material is increased. As a result, the outer coating layer 6 can be efficiently formed even in a short time.

As the solvent to be used in the solution of the low water-soluble material, any of the above-mentioned various solvents to be used in the binder solution is preferably used, however, preferably, a solvent which sparingly dissolves the above organic binder is used.

For example, in the case where the organic binder is formed of a water-soluble material, as the solvent to be contained in the solution of the low water-soluble material in this step, an oil-soluble solvent is preferably used. On the other hand, in the case where the organic binder is formed of an oil-soluble material, a water-soluble solvent is preferably used in this step.

The concentration of the low water-soluble material in the solution is preferably from 0.5 to 20% by weight, more preferably from 1 to 15% by weight, further more preferably from 2 to 10% by weight. According to this configuration, the outer coating layer 6 having a uniform thickness can be obtained.

The granulated powder according to the invention can be formed as described above.

Incidentally, the use of the granulated powder according to the invention is not particularly limited. It can be preferably used in, for example, the production of a molded body containing the granulated powder, particularly the production of a sintered body obtained by sintering the molded body containing the granulated powder.

### Method for Producing Sintered Body

Hereinafter, one example of the method for producing a sintered body will be described.

### Molding

First, the granulated powder according to the invention as described above is molded using a press molding machine, whereby a molded body having a desired shape and dimension is produced. The granulated powder according to the invention itself is dense and has a high filling property. Therefore, a molded body having a high density can be produced, and a sintered body having a high density and a low shrinkage ratio can be obtained in the end.

Incidentally, the shape and dimension of the molded body to be produced are determined in expectation of a shrinkage due to the subsequent degreasing and sintering treatments. Further, the molding method is not limited to press molding, and compression molding, injection molding, or the like may be employed.

### Degreasing Treatment

The molded body obtained in the above-mentioned molding step is subjected to a degreasing treatment (binder removal treatment), whereby a degreased body is obtained. The degreasing treatment is not particularly limited. It can be performed by a heat treatment in a non-oxidative atmosphere, for example, under vacuum or a reduced pressure (for example, 1×10⁻¹ to 1×10⁻⁶ Torr), or in a gas such as nitrogen, argon, hydrogen, or dissociated ammonia. In this case, the condition for the heat treatment slightly varies depending on the decomposition initiation temperature of the organic binder or the like, however, the heat treatment is preferably performed at a temperature of about 100° C. to 750° C. for about 0.5 to 40 hours, more preferably performed at a temperature of about 150° C. to 700° C. for about 1 to 24 hours.

Degreasing by such a heat treatment may be performed by being divided into a plurality of steps (stages) for various purposes (for example, for the purpose of reducing the degreasing time, etc.). In this case, for example, a method in which degreasing is performed at a low temperature in the former half and at a high temperature in the latter half, a method in which degreasing at a low temperature and degreasing at a high temperature are alternately repeated, or the like can be used.

Incidentally, it is not necessary to completely remove the organic binder by the degreasing treatment, and for example, a part thereof may remain at the time of completion of the degreasing treatment.

### Firing

The degreased body obtained in the above-mentioned degreasing treatment is fired in a firing furnace to effect sintering, whereby a desired sintered body is obtained. By this firing, the metal powder constituting the granulated powder is dispersed to cause grain growth, and a sintered body which is dense as a whole, in other words, has a high density and a low porosity can be obtained.

The firing temperature at the time of firing slightly varies depending on the composition of the granulated powder or the like. For example, in the case of using an Fe-based alloy powder, the firing temperature is preferably 900° C. or higher but lower than 1200° C., more preferably from 1000° C. to 1180° C. When the firing temperature falls within the above range, a sintered body can be efficiently produced using a firing furnace which does not have a special heat resistant structure, is relatively inexpensive, and is excellent in mass production of a sintered body. Incidentally, if the firing temperature is lower than the lower limit defined above, sintering of the metal powder may not sufficiently proceed, and the porosity of a finally obtained sintered body may be increased, and therefore, a sufficient mechanical strength may not be obtained. On the other hand, if the firing temperature exceeds the upper limit defined above, a firing furnace which has a special heat resistant structure is needed, and therefore, ease of firing is reduced.

The time of holding the maximum temperature during firing is preferably from about 0.5 to 8 hours, more preferably from about 0.75 to 5 hours.

In particular, by using a material having a high binding property and high thermal decomposability such as polyvinyl alcohol or polyvinylpyrrolidone as the organic binder, the amount of the organic binder used can be reduced, and also the distance between the particles of the metal particles can be reduced, and therefore, the sintering initiation temperature can be decreased. As a result, even if firing is performed at a relatively low temperature in a short time, a dense sintered body can be obtained.

The firing atmosphere is not particularly limited, however, a reduced pressure (vacuum) atmosphere or a non-oxidative atmosphere is preferred. According to this configuration, deterioration of properties due to metal oxidation can be prevented. A preferred firing atmosphere is a reduced pressure (vacuum) atmosphere at 1 Torr or less (more preferably at 1×10⁻² to 1×10⁻⁶ Torr), an inert gas atmosphere of nitrogen, argon, or the like at 1 to 760 Torr, or a hydrogen gas atmosphere at 1 to 760 Torr.

The firing atmosphere may be changed in the course of firing. For example, the initial firing atmosphere is set to a reduced pressure (vacuum) atmosphere at 1×10⁻² to 1×10⁻⁶ Torr, which can be changed to an inert gas atmosphere as described above in the course of firing.

The firing may be performed in two or more stages. For example, first firing and second firing, in which the firing conditions are different such that the firing temperature in the second firing is set to higher than that in the first firing, may be performed.

The thus obtained sintered body may be used for any purpose, and as the use thereof, various machine parts and the like can be exemplified.

The relative density of the thus obtained sintered body varies depending on the use thereof or the like, however, for example, it is expected to be more than 93%, preferably 94% or more. Such a sintered body has a particularly excellent mechanical property. Further, by using the granulated powder according to the invention, even if it is fired at a low temperature, such a sintered body having an excellent mechanical property can be efficiently produced.

Hereinabove, the invention is described based on preferred embodiments, however, the invention is not limited to these.

For example, in the method for producing a granulated powder, an additional step can be added as needed.

The device to be used in the method for producing a granulated powder according to the invention is not limited to one described in the above embodiment. For example, in the above embodiment, the case where a tumbling granulator is used is described, however, a fluidized bed granulator which performs granulation by means of a fluidizing action, a tumbling fluidized bed granulator which performs granulation by means of a tumbling and fluidizing action, a spray drying apparatus which performs spray drying, or the like may be used.

### EXAMPLES

### 1. Production of Granulated Powder

### Example 1A

1) First, as a starting material powder, a stainless steel powder (SUS-316L, true density: 7.98 g/cm³, manufactured by Epson Atmix Corporation) having an average particle diameter of 6 μm produced by a water atomization method was prepared.

2) As an organic binder, polyvinyl alcohol (RS-1717, manufactured by Kuraray Co., Ltd.) was prepared. The saponification and polymerization degrees of polyvinyl alcohol were 93 and 1700, respectively. As a solvent, ion exchanged water was prepared.

Subsequently, polyvinyl alcohol was mixed with ion exchanged water, and the resulting mixture was cooled to room temperature, whereby an organic binder solution was prepared. The addition amount of the solvent was set to 50 g per gram of the organic binder.

3) Subsequently, the starting material powder was placed in a treatment vessel of a tumbling granulator (VG-25, manufactured by Powrex Corporation). Then, the starting material powder was allowed to tumble under the following condition while spraying the organic binder solution from a spray nozzle of the tumbling granulator. The addition amount of polyvinyl alcohol was set to 0.8 parts by weight based on 100 parts by weight of the metal powder. By doing this, secondary particles having an average particle diameter of 75 μm was obtained.

### Tumbling Condition

Rotation speed of blade: 200 rpm

Rotation speed of cross screw: 2500 rpm

Supply rate of binder solution: 200 g/min

Granulation time: 90 min

4) Subsequently, an alkylamine derivative (acetate) which is a low water-soluble material was dissolved in toluene, whereby a solution of the low water-soluble material was prepared.

Then, the secondary particles were allowed to tumble while spraying the solution of the low water-soluble material from the spray nozzle of the tumbling granulator. The addition amount of the alkylamine derivative was set to 0.3 parts by weight based on 100 parts by weight of the metal powder. By doing this, an outer coating layer was formed on the surfaces of the secondary particles, whereby a granulated powder was obtained.

### Examples 2A to 8A

Granulated powders were obtained in the same manner as in Example 1A except that the amount of the organic binder, and the type and amount of low water-soluble material were changed as shown in Table 1, respectively.

### Example 9A

Prior to the production of the secondary particles, the solution of the low water-soluble material was sprayed onto the starting material powder, followed by drying. By doing this, an inner coating layer was formed so as to cover the surface of the starting material powder.

Thereafter, by using the starting material powder having the inner coating layer formed on the surface thereof, a granulated powder was obtained in the same manner as in Example 1A.

### Example 10A

Prior to the production of the secondary particles, the solution of the low water-soluble material was sprayed onto the starting material powder, followed by drying. By doing this, an inner coating layer was formed so as to cover the surface of the starting material powder.

Thereafter, by using the starting material powder having the inner coating layer formed on the surface thereof, a granulated powder was obtained in the same manner as in Example 4A.

### Examples 11A to 18A

Granulated powders were obtained in the same manner as in Examples 1A to 8A, respectively, except that the organic binder was changed to polyvinylpyrrolidone (PVP K-90, manufactured by BASF Co., Ltd.). This polyvinylpyrrolidone has a weight-average molecular weight of 360,000.

### Example 19A

Prior to the production of the secondary particles, the solution of the low water-soluble material was sprayed onto the starting material powder, followed by drying. By doing this, an inner coating layer was formed so as to cover the surface of the starting material powder.

Thereafter, by using the starting material powder having the inner coating layer formed on the surface thereof, a granulated powder was obtained in the same manner as in Example 11A.

### Example 20A

Prior to the production of the secondary particles, the solution of the low water-soluble material was sprayed onto the starting material powder, followed by drying. By doing this, an inner coating layer was formed so as to cover the surface of the starting material powder.

Thereafter, by using the starting material powder having the inner coating layer formed on the surface thereof, a granulated powder was obtained in the same manner as in Example 14A.

### Comparative Examples 1A and 2A

Granulated powders were obtained in the same manner as in Examples 1A and 5A, respectively, except that the formation of the outer coating layer was omitted.

### Comparative Examples 3A and 4A

Granulated powders were obtained in the same manner as in Examples 11A and 15A, respectively, except that the formation of the outer coating layer was omitted.

### Example 1B

A granulated powder was obtained in the same manner as in Example 1A except that a 2% Ni—Fe alloy powder (true density: 7.827 g/cm³, manufactured by Epson Atmix Corporation) having an average particle diameter of 6 μm produced by a water atomization method was used as the starting material powder.

The composition of the 2% Ni—Fe is as follows: C, 0.4 to 0.6% by mass, Si: 0.35% by mass or less, Mn: 0.8% by mass or less, P: 0.03% by mass or less, S: 0.045% by mass or less, Ni: 1.5 to 2.5% by mass, Cr: 0.2% by mass or less, and Fe: remainder.

Further, in the step 4), the addition amount of the low water-soluble material was set to 0.01 parts by weight based on 100 parts by weight of the metal powder.

### Examples 2B to 8B

Granulated powders were obtained in the same manner as in Example 1B except that the addition amount of the low water-soluble material was changed as shown in Table 2, respectively.

### Example 9B

A granulated powder was obtained in the same manner as in Example 11A except that a 2% Ni—Fe alloy powder (true density: 7.827 g/cm³, manufactured by Epson Atmix Corporation) having an average particle diameter of 6 μm produced by a water atomization method was used as the starting material powder.

The composition of the 2% Ni—Fe is as follows: C, 0.4 to 0.6% by mass, Si: 0.35% by mass or less, Mn: 0.8% by mass or less, P: 0.03% by mass or less, S: 0.045% by mass or less, Ni: 1.5 to 2.5% by mass, Cr: 0.2% by mass or less, and Fe: remainder.

Further, in the step 4), the addition amount of the low water-soluble material was set to 0.01 parts by weight based on 100 parts by weight of the metal powder.

### Examples 10B to 16B

Granulated powders were obtained in the same manner as in Example 9B except that the addition amount of the low water-soluble material was changed as shown in Table 2, respectively.

### Comparative Example 1B

A granulated powder was obtained in the same manner as in Example 1B except that the formation of the outer coating layer was omitted.

### Comparative Example 2B

A granulated powder was obtained in the same manner as in Example 9B except that the formation of the outer coating layer was omitted.

### 2. Evaluation of Granulated Powder

### 2.1 Evaluation for Fluidity

The fluidity of each of the granulated powders obtained in the respective Examples and Comparative Examples was measured in accordance with Test Method for Fluidity of Metal Powders specified in JIS Z 2502.

### 2.2 Evaluation for Sintering Density

Each of the granulated powders obtained in the respective Examples and Comparative Examples was molded under the following molding condition.

Molding Condition
Molding method: press molding method
Molding shape: cube with a side of 20 mm
Molding pressure: 600 MPa (6 t/cm2)

Subsequently, an obtained molded body was degreased under the following degreasing condition.

### Degreasing Condition

Degreasing temperature: 600° C.

Degreasing time: 1 hour

Degreasing atmosphere: nitrogen gas atmosphere

Subsequently, the obtained degreased body was fired under the following firing condition, whereby a sintered body was obtained.

### Firing Condition

Firing temperature: 1150° C.

Firing time: 3 hours

Firing atmosphere: reduced pressure Ar atmosphere

Atmospheric pressure: 1.3 kPa (10 Torr)

Subsequently, the density of the obtained sintered body was measured by a method according to the Archimedes method specified in JIS Z 2501. Further, the relative density of the sintered body was calculated from the measured sintering density and the true density of the metal powder.

### 2.3 Evaluation for Dimensional Accuracy

Subsequently, the width dimension of the obtained sintered body was measured using a micrometer. Then, evaluation was performed for the measurements according to the following evaluation criteria based on the “Permissible Deviations in Widths Without Tolerance” specified in JIS B 0411

(Permissible Deviations in Dimensions without Tolerance Indication for Metallic Sintered Products).

The width of the sintered body refers to a dimension in the direction orthogonal to the direction of compression at the time of press molding.

### Evaluation Criteria

A: Grade is fine (tolerance is ±0.1 mm or less)

B: Grade is medium (tolerance exceeds ±0.1 mm but is ±0.2 mm or less)

C: Grade is coarse (tolerance exceeds ±0.2 mm but is ±0.5 mm or less)

D: Outside the permissible tolerance

Hereinafter, the results of the evaluation items described in 2.1 to 2.3 are shown in Tables 1 and 2.

TABLE 1

| | | Production condition for granulated powder | | | | | | | | |
|---|---|---|---|---|---|---|---|---|---|---|
| | | | | Inner coating layer | | Outer coating layer | | | | |
| | | | | Low water-soluble | | Low water-soluble | | Evaluation results | | |
| | | Organic binder | | material | | material | | Fluidity of | | |
| | Metal | | Parts | | Parts | | Parts | granulated | Relative | Dimensional |
| | powder | Compo- | by | | by | | by | powder | density | accuracy |
| | Composition | sition | weight | Composition | weight | Composition | weight | Sec/50 g | % | — |
| Example 1A | SUS-316L | PVA | 0.8 | — | — | Alkylamine | 0.30 | 32.1 | 96.5 | A |
| | | | | | | derivative | | | | |
| Example 2A | SUS-316L | PVA | 0.8 | — | — | Cycloalkylamine | 0.30 | 32.5 | 96.1 | B |
| | | | | | | derivative | | | | |
| Example 3A | SUS-316L | PVA | 0.8 | — | — | Alkanolamine | 0.30 | 32.6 | 96.0 | B |
| | | | | | | derivative | | | | |
| Example 4A | SUS-316L | PVA | 0.8 | — | — | Methyl | 0.30 | 31.9 | 96.8 | A |
| | | | | | | polyacrylate | | | | |
| Example 5A | SUS-316L | PVA | 3.0 | — | — | Alkylamine | 0.30 | — | 95.2 | B |
| | | | | | | derivative | | | | |
| Example 6A | SUS-316L | PVA | 3.0 | — | — | Cycloalkylamine | 0.30 | — | 94.7 | B |
| | | | | | | derivative | | | | |
| Example 7A | SUS-316L | PVA | 3.0 | — | — | Alkanolamine | 0.30 | — | 94.5 | B |
| | | | | | | derivative | | | | |
| Example 8A | SUS-316L | PVA | 3.0 | — | — | Methyl | 0.30 | — | 95.6 | B |
| | | | | | | polyacrylate | | | | |
| Example 9A | SUS-316L | PVA | 0.8 | Alkylamine | 0.30 | Alkylamine | 0.30 | — | 97.9 | A |
| | | | | derivative | | derivative | | | | |
| Example 10A | SUS-316L | PVA | 0.8 | Methyl | 0.30 | Methyl | 0.30 | — | 98.1 | A |
| | | | | polyacrylate | | polyacrylate | | | | |
| Example 11A | SUS-316L | PVP | 0.8 | — | — | Alkylamine | 0.30 | 30.2 | 96.0 | A |
| | | | | | | derivative | | | | |
| Example 12A | SUS-316L | PVP | 0.8 | — | — | Cycloalkylamine | 0.30 | 30.8 | 95.6 | B |
| | | | | | | derivative | | | | |
| Example 13A | SUS-316L | PVP | 0.8 | — | — | Alkanolamine | 0.30 | 31.2 | 95.4 | B |
| | | | | | | derivative | | | | |
| Example 14A | SUS-316L | PVP | 0.8 | — | — | Methyl | 0.30 | 30.1 | 96.4 | A |
| | | | | | | polyacrylate | | | | |
| Example 15A | SUS-316L | PVP | 3.0 | — | — | Alkylamine | 0.30 | — | 94.6 | B |
| | | | | | | derivative | | | | |
| Example 16A | SUS-316L | PVP | 3.0 | — | — | Cycloalkylamine | 0.30 | — | 94.1 | B |
| | | | | | | derivative | | | | |
| Example 17A | SUS-316L | PVP | 3.0 | — | — | Alkanolamine | 0.30 | — | 94.0 | B |
| | | | | | | derivative | | | | |
| Example 18A | SUS-316L | PVP | 3.0 | — | — | Methyl | 0.30 | — | 95.0 | B |
| | | | | | | polyacrylate | | | | |
| Example 19A | SUS-316L | PVP | 0.8 | Alkylamine | 0.30 | Alkylamine | 0.30 | — | 97.3 | A |
| | | | | derivative | | derivative | | | | |
| Example 20A | SUS-316L | PVP | 0.8 | Methyl | 0.30 | Methyl | 0.30 | — | 97.7 | A |
| | | | | polyacrylate | | polyacrylate | | | | |
| Comparative | SUS-316L | PVA | 0.8 | — | — | — | — | 35.4 | 93.1 | C |
| Example 1A | | | | | | | | | | |
| Comparative | SUS-316L | PVA | 3.0 | — | — | — | — | — | 88.8 | D |
| Example 2A | | | | | | | | | | |
| Comparative | SUS-316L | PVP | 0.8 | — | — | — | — | 33.9 | 92.6 | C |
| Example 3A | | | | | | | | | | |
| Comparative | SUS-316L | PVP | 3.0 | — | — | — | — | — | 87.5 | D |
| Example 4A | | | | | | | | | | |

As is apparent from Table 1, it was confirmed that each of the granulated powders obtained in the respective Examples has high fluidity and is capable of producing a sintered body having a high density. In particular, in the case where an alkylamine material or an acrylic resin was used as the low water-soluble material, the tendency was prominent.

TABLE 2

| | | Production condition for granulated powder | | | | | | | | |
|---|---|---|---|---|---|---|---|---|---|---|
| | | | | Inner coating layer | | Outer coating layer | | | | |
| | | | | Low water-soluble | | Low water-soluble | | Evaluation results | | |
| | | Organic binder | | material | | material | | Fluidity of | | |
| | Metal | | Parts | | Parts | | Parts | granulated | Relative | Dimensional |
| | powder | | by | | by | | by | powder | density | accuracy |
| | Composition | Composition | weight | Composition | weight | Composition | weight | Sec/50 g | % | — |
| Example 1B | 2% Ni—Fe | PVA | 0.8 | — | — | Methyl | 0.01 | 34.2 | 95.7 | A |
| | | | | | | polyacrylate | | | | |
| Example 2B | 2% Ni—Fe | PVA | 0.8 | — | — | Methyl | 0.05 | 33.6 | 95.7 | A |
| | | | | | | polyacrylate | | | | |
| Example 3B | 2% Ni—Fe | PVA | 0.8 | — | — | Methyl | 0.10 | 33.0 | 95.4 | A |
| | | | | | | polyacrylate | | | | |
| Example 4B | 2% Ni—Fe | PVA | 0.8 | — | — | Methyl | 0.20 | 32.4 | 94.7 | B |
| | | | | | | polyacrylate | | | | |
| Example 5B | 2% Ni—Fe | PVA | 0.8 | — | — | Methyl | 0.30 | 31.9 | 94.0 | B |
| | | | | | | polyacrylate | | | | |
| Example 6B | 2% Ni—Fe | PVA | 0.8 | — | — | Methyl | 0.50 | 33.2 | 93.9 | B |
| | | | | | | polyacrylate | | | | |
| Example 7B | 2% Ni—Fe | PVA | 0.8 | — | — | Methyl | 0.80 | 33.8 | 95.7 | A |
| | | | | | | polyacrylate | | | | |
| Example 8B | 2% Ni—Fe | PVA | 0.8 | — | — | Methyl | 1.00 | 34.1 | 95.6 | A |
| | | | | | | polyacrylate | | | | |
| Example 9B | 2% Ni—Fe | PVP | 0.8 | — | — | Methyl | 0.01 | 32.7 | 95.2 | A |
| | | | | | | polyacrylate | | | | |
| Example 10B | 2% Ni—Fe | PVP | 0.8 | — | — | Methyl | 0.05 | 32.1 | 96.3 | A |
| | | | | | | polyacrylate | | | | |
| Example 11B | 2% Ni—Fe | PVP | 0.8 | — | — | Methyl | 0.10 | 31.6 | 96.1 | A |
| | | | | | | polyacrylate | | | | |
| Example 12B | 2% Ni—Fe | PVP | 0.8 | — | — | Methyl | 0.20 | 31.0 | 95.8 | A |
| | | | | | | polyacrylate | | | | |
| Example 13B | 2% Ni—Fe | PVP | 0.8 | — | — | Methyl | 0.30 | 30.5 | 95.8 | A |
| | | | | | | polyacrylate | | | | |
| Example 14B | 2% Ni—Fe | PVP | 0.8 | — | — | Methyl | 0.50 | 31.8 | 95.8 | A |
| | | | | | | polyacrylate | | | | |
| Example 15B | 2% Ni—Fe | PVP | 0.8 | — | — | Methyl | 0.80 | 32.4 | 95.8 | A |
| | | | | | | polyacrylate | | | | |
| Example 16B | 2% Ni—Fe | PVP | 0.8 | — | — | Methyl | 1.00 | 32.7 | 97.7 | A |
| | | | | | | polyacrylate | | | | |
| Comparative | 2% Ni—Fe | PVA | 0.8 | — | — | — | — | 34.7 | 94.5 | C |
| Example 1B | | | | | | | | | | |
| Comparative | 2% Ni—Fe | PVP | 0.8 | — | — | — | — | 33.2 | 93.4 | C |
| Example 2B | | | | | | | | | | |

As is apparent from Table 2, the fluidity of each of the granulated powders obtained in the respective Examples could be particularly increased by optimizing the addition amount of the low water-soluble material, and the density of the resulting sintered body could be further increased. In addition, the dimensional accuracy thereof was improved.

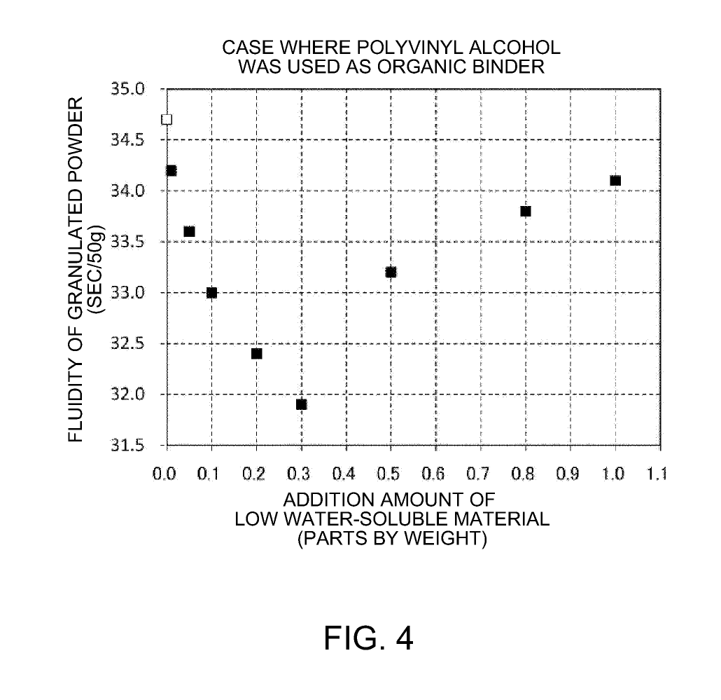

FIG. 4 is a graph showing the distribution of the granulated powders obtained in the respective Examples 1B to 8B and Comparative Example 1B in the case where polyvinyl alcohol was used as the organic binder, with the horizontal axis representing the addition amount of the low water-soluble material, and the vertical axis representing the fluidity of the granulated powder. In the graph, the granulated powders of the respective Examples are indicated by black squares, and the granulated powder of Comparative Example 1B is indicated by a white square.

From FIG. 4, it is confirmed that when the addition amount of the low water-soluble material falls within a range from 0.02 to 0.8 parts by weight based on 100 parts by weight of the metal powder, the fluidity of the granulated powder is particularly increased (the time required for dropping is decreased). Further, in this case, the relative density of the sintered body is also increased, and it is found that a sintered body having a high density was produced.

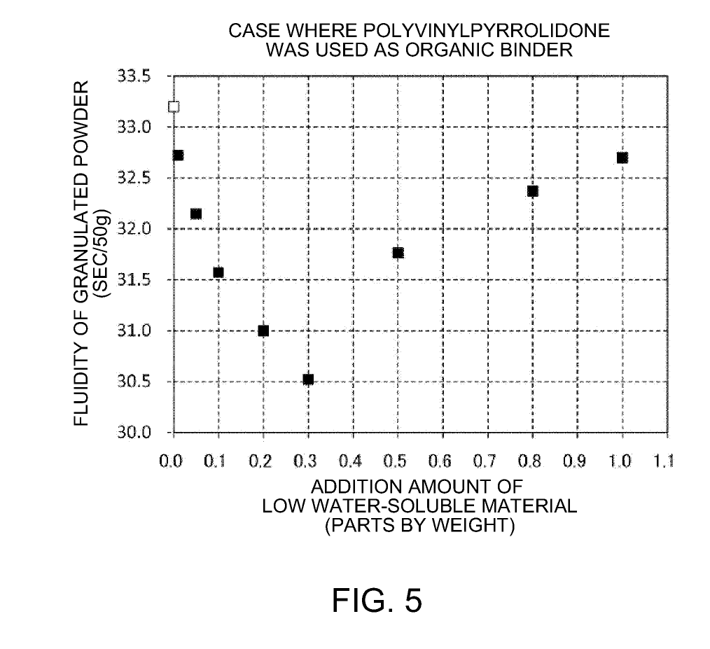

On the other hand, FIG. 5 is a graph showing the distribution of the granulated powders obtained in the respective Examples 9B to 16B and Comparative Example 2B in the case where polyvinylpyrrolidone was used as the organic binder, with the horizontal axis representing the addition amount of the low water-soluble material, and the vertical axis representing the fluidity of the granulated powder. Incidentally, in the graph, the granulated powders of the respective Examples are indicated by black squares, and the granulated powder of Comparative Example 2B is indicated by a white square.

From FIG. 5, it is confirmed that when the addition amount of the low water-soluble material falls within a range from 0.02 to 0.8 parts by weight based on 100 parts by weight of the metal powder, the fluidity of the granulated powder is particularly increased (the time required for dropping is decreased) in the same manner as in FIG. 4. Further, in this case, the relative density of the sintered body is also increased, and it is found that a sintered body having a high density was produced.

By using the granulated powder obtained in Comparative Example 1B, a supplementary experiment in which a sintered body was obtained by changing the firing temperature from 1150° C. to 1250° C. was performed. The relative density of the resulting sintered body exceeded 97%, which could be improved to a level equivalent to the sintering density of the sintered body obtained using any of the granulated powders obtained in the respective Examples. From this result, it was revealed that by using the granulated powder according to the invention, a sintered body equivalent to that obtained by performing firing at a high temperature using the granulated powder in the related art can be produced even if it is fired at a lower temperature. Accordingly, since firing can be performed using a firing furnace which is widely used and inexpensive in a shorter time, it can be expected to reduce the cost and to increase the efficiency of firing.

The entire disclosure of Japanese Patent Application No. 2010-047142, filed Mar. 3, 2010 is expressly incorporated by reference herein.

What is claimed is:

1. A granulated powder, comprising:
secondary particles including a plurality of metal particles bound to one another by an organic binder; and
an outer coating layer covering the surfaces of the secondary particles, wherein
the outer coating layer is formed of a low water-soluble material having a lower water solubility than the organic binder.

2. The granulated powder according to claim 1, wherein an amount of the outer coating layer is from 0.02 to 0.8 parts by weight based on 100 parts by weight of the metal particles.

3. The granulated powder according to claim 1, wherein the low water-soluble material is any of an organic amine or a derivative thereof, and an acrylic resin.

4. The granulated powder according to claim 1, wherein the low water-soluble material is an organic amine or a derivative thereof, and the outer coating layer is at least partly in contact with the surfaces of the metal particles.

5. The granulated powder according to claim 3, wherein the organic amine or a derivative thereof is at least one of an alkylamine, a cycloalkylamine, an alkanolamine, and a derivative thereof.

6. The granulated powder according to claim 3, wherein the organic amine derivative is any of a nitrite of an organic amine, a carboxylate of an organic amine, a chromate of an organic amine, and an acetate of an organic amine.

7. The granulated powder according to claim 1, wherein the organic binder contains polyvinyl alcohol or polyvinylpyrrolidone.

8. The granulated powder according to claim 1, wherein each of the metal particles is covered with an inner coating layer formed of the same material as the outer coating layer.

9. The granulated powder according to claim 1, wherein the metal particles comprise an Fe-based alloy powder and the granulated powder has a fluidity of 33 (sec/50 g) or less, as measured in accordance with Test Method for Fluidity of Metal Powders specified in JIS Z 2502.

10. A method for producing a granulated powder, comprising:
providing a plurality of metal particles;
while tumbling or flowing the plurality of metal particles, simultaneously supplying a solution of an organic binder to the plurality of metal particles, thereby obtaining a secondary particles; and
supplying a solution of a low water-soluble material having a lower water solubility than the organic binder to the secondary particles, thereby forming an outer coating layer.

11. The method for producing a granulated powder according to claim 10, wherein the solution of the low water-soluble material is supplied by spraying.
